(19) United States
(12) Patent Application Publication
(10) Pub. No.: US 2008/0245477 A1
(43) Pub. Date: Oct. 9, 2008

(54) CARTRIDGE ADHESIVE FORMULATION

(76) Inventors: Roland John Koestner, Penfield, NY (US); Scott L. Salcido, White City, OR (US)

Correspondence Address: Susan L. Parulski;Patent Legal Staff, Carestream Health, Inc., 150 Verona Street, Rochester, NY, 14608, US

(21) Appl. No.: 11/853,983

(22) Filed: Sep. 12, 2007

Related U.S. Application Data
(60) Provisional application No. 60/910,700, filed on Apr. 9, 2007.

(51) Int. Cl. C09J 147/00; C08L 9/00

(52) U.S. Cl. 156/332; 525/232; 525/386

(57) ABSTRACT

A resealable adhesive formulation comprises a paraffinic hydrocarbon, an aliphatic ester, an aliphatic alcohol, an acrylate adhesive, a surfactant free of perfluoroalkylsulfonyl groups and optionally a tackifying resin. The adhesive is capable of multiple open/close cycles and is particularly useful for resealable cassettes and cartridges for medical imaging films.

### CROSS REFERENCE TO RELATED APPLICATIONS

Reference is made to, and priority is claimed from, Provisional Patent Application No. 60/910,700 entitled “CARTRIDGE ADHESIVE FORMULATION”, filed on Apr. 9, 2007 in the names of Roland J. Koestner and Scott L. Salcido, and which is assigned to the assignee of this application.

### FIELD OF THE INVENTION

This invention relates generally to adhesives for the packaging of photographic and photothermographic films and in particular to adhesives for resealable cassettes and cartridges for medical imaging films. This invention also relates to cassettes and cartridges using these materials and for methods of sealing such cassettes and cartridges.

### BACKGROUND OF THE INVENTION

U.S. Pat. No. 5,473,400 (Lemberger et al.) and discloses a film cartridge for multiple sheets of photosensitive films (that is, photographic and photothermographic films) that is capable of being resealed after it has been opened. The cartridge is configured to be conveniently loaded directly into an imager under daylight conditions.

Such cartridges include an optically opaque polymer film-receiving cartridge tray and a flexible, optically opaque polymer cover. The cover is resealably mounted to a flange on the cartridge tray by an adhesive. Upon insertion into the imager the cover is peeled back (that is, rolled up) to allow feeding of the photosensitive imageable film. Since it is sometimes necessary to load an imager with a different type or size of film before all the film already in the imager has been used, the cartridge can be resealed and conveniently removed from the imager under daylight conditions without exposing and thus wasting any remaining film.

Use of the resealable cartridge disclosed in the Lemberger et al. patent requires a mechanism that can open and reseal the cartridge within the imager. The mechanism must be capable of reliably performing the opening and closing functions many times. Such mechanisms are described in U.S. Pat. No. 5,132,724 (Lemberger et al) and U.S. Pat. No. 5,229,585 (Lemberger et al.). Similarly, the adhesive must be capable of providing a light-tight, resealable seal between the cover and the film tray. In addition, to prevent the cover from sticking to itself as the cover is peeled back and then resealed during opening and closing, the adhesive must remain adhered to the flange of the cartridge tray and not transfer to the cover sheet upon opening and closing.

Many adhesives used for resealable closures contain fluoro-chemical coating aids and surfactants and are coated from organic solvents. The fluorochemical coating aids often contain perfluoroctylsulfonate groups. However, it has been learned that coating aids containing these groups may present environmental concerns. Similarly, widely used coating solvents such as toluene are also facing environmental concerns as hazardous air pollutants (HAP).

Thus, there remains a need for adhesives for resealable closures whose formulations are more environmentally friendly.

### SUMMARY OF THE INVENTION

In one aspect the invention provides a resealable adhesive formulation comprising:

(a) from about 50 to about 75 wt % of a paraffinic hydrocarbon having a boiling point of between about 94 and about 140° C.,

(b) from about 10 to about 25 wt % of an aliphatic ester having 10 or fewer carbon atoms,

(c) from about 5 to about 15 wt % of an aliphatic alcohol having 5 or fewer carbon atoms,

(d) from about 5 to about 15 wt % of a (meth)acrylate adhesive, and

(e) from about 0.05 to about 0.7 wt % of a surfactant free of perfluoro-alkylsulfonyl groups and containing perfluoroalkyl groups or perfluoroalkyl groups attached to an ethylene group pendant from a polymer chain.

In another aspect the invention provides, a resealable adhesive formulation comprising:

(a) from about 55 to about 65 wt % of an isoparaffinic hydrocarbon having a boiling point of between about 94 and about 140° C.,

(b) from about 15 to about 20 wt % of an aliphatic ester having 10 or fewer carbon atoms,

(c) from about 8 to about 12 wt % of an aliphatic alcohol having 5 or fewer carbon atoms,

(d) from about 7 to about 12 wt % a (meth)acrylate adhesive,

(e) a tackifying resin in an amount of from about 1 to about 5 wt % that of the (meth)acrylate adhesive polymer.

(f) from about 0.05 to about 0.7 wt % of a surfactant free of perfluoro-alkylsulfonyl groups that is a poly(meth)acrylate copolymer containing one or more perfluoroalkyl groups or perfluoroalkyl groups attached to an ethylene group and containing one or more alkyl groups pendant from a polyacrylate or polymethacrylate chain.

In a further aspect the invention provides a method of sealing a cassette or cartridge comprising:

(a) applying the resealable adhesive described above to the flange of the cassette or cartridge tray,

(b) drying the adhesive, and

(c) applying a flexible cover to the adhesively coated flange of the cassette or cartridge tray.

Other aspects, advantages, and benefits of the present invention are apparent from the detailed description, examples, and claims provided in this application.

### DETAILED DESCRIPTION OF THE INVENTION

We have found that an adhesive formulation comprising a paraffinic hydrocarbon, an aliphatic ester, an aliphatic alcohol, a (meth)acrylate adhesive, a surfactant free of perfluoroalkylsulfonyl groups, and optionally a tackifying resin is capable of multiple open/close cycles and is particularly useful for resealable cassettes and cartridges for medical imaging films such as photographic and photothermographic films.

The adhesive formulation can be applied to the flange of a cassette or a cartridge tray and dried. When a flexible cover such as optically opaque polymer cover is adhered to the flange of the cassette the adhesive remains adhered to the flange of the cartridge tray and does not transfer to the cover sheet upon opening and closing of the cover sheet.

The adhesive formulation contains at least one paraffinic hydrocarbon solvent having a boiling point of between about 94 and about 140° C. Representative examples include, heptane, octane, methylcyclohexane, Isopar C, Isopar E, (ISOPAR® is a trade name of EXXON Corporation), Shellsol TC (Shellsol™ is a trade name of Shell Oil Company). Mixtures of paraffinic hydrocarbons may be used. Heptane and Isopar E are typically useful solvents. Isoparaffinc solvents are more typically useful. The paraffinic hydrocarbon solvent is generally present in an amount of from about 50 to about 75 wt % and typically in an amount of from about 55 to about 65 wt % of the adhesive formulation.

The adhesive formulation also contains an aliphatic ester having 10 or fewer carbon atoms that is derived from an aliphatic acid and an aliphatic alcohol. Typical aliphatic acids include acetic, propionic, butyric, and pentanoic acid and typical aliphatic alcohols include ethyl, propyl, iso-propyl, butyl, pentyl, and neopentyl alcohol. Either or both of the aliphatic acid and aliphatic alcohol portions may be straight chain or branched and mixtures of such esters may be used. Typical esters include ethyl acetate, n-propyl acetate, iso-propyl acetate n-butyl acetate, sec-butyl acetate, iso-butyl acetate, butyl propionate, and ethyl butyrate. The ester generally constitutes from about 10 to about 25 wt % and typically from about 15 to about 20 wt % of the adhesive formulation.

The adhesive formulation also contains an aliphatic alcohol having 5 or fewer carbon atoms. Typical aliphatic alcohols include ethyl, n-propyl, iso-propyl, n-butyl, iso-butyl, and pentyl alcohol. The aliphatic alcohols may be straight chain or branched and mixtures of such alcohols may be used. The alcohol generally constitutes from about 5 to about 15 wt % and typically from about 8 to about 12 wt % of the adhesive formulation.

The adhesive formulation further contains a pressure sensitive acrylic adhesive polymer such as an acrylate or a methacrylate. (Meth)acrylate pressure-sensitive adhesives generally have a glass transition temperature of about −20° C. or less and may comprise from 100 to about 80 wt % of a C₃ to C₁₂ alkyl ester component such as, for example, iso-octyl acrylate, 2-ethyl-hexyl acrylate and n-butyl acrylate and from 0 to about 20 wt % of a polar component such as, for example, acrylic acid, methacrylic acid, ethylene vinyl acetate, N-vinyl pyrrolidone and styrene macromer. Other (meth)acrylates such as methyl-acrylate and ethyl-acrylate may also be present. Cyanoacrylates and acrylonitrile may also be present. Preferably, the (meth)acrylic pressure-sensitive adhesives include from 0 to about 20 wt % of acrylic acid and from 100 to about 80 wt % of a C₆ to C₁₂ alkyl ester acrylate. Copolymers of these acrylates can also be used. Examples of such polymers include “V-19800 Developmental Material (Experimental)” from 3M Company, and Morstik™ 607 from Rohm & Haas. The (meth)acrylate adhesive generally constitutes from about 5 to about 15 wt % and typically from about 7 to about 12 wt % of the adhesive formulation.

The adhesive formulation also contains a surfactant free of perfluoroalkylsulfonyl groups. Such surfactants generally contain one or more perfluoroalkyl groups and typically contain one or more perfluoroalkyl groups attached to an ethylene group. These groups are usually pendant from a polymer chain such as a polyacrylate or a polymethacrylate. Other groups such as vinyl chloride and crosslinkers may be included in the polymer chain. Copolymers with alkyl groups pendant from a polymer chain such as an alkyl polyacrylate or an alkyl polymethacrylate are also useful. Surfactants with these features are widely available and are sold under a variety of trade names such as Zonyl FSG (DuPont), Modiper F3035 (Nippon Oil and Fats), Unidyne NS-1602 and NS-1603 (Daikin America). The surfactant generally constitutes from about 0.05 to about 0.7 wt % % of the adhesive formulation.

The adhesive formulation may optionally contain a tackifying resin. Tackifying resins are used in pressure sensitive adhesives (PSA) and in hot melt adhesives (HMA) to increase adhesion strength. Typical tackifying resins include terpene-based resins, rosin-based resins (such as an ester of gum rosin), aliphatic hydrocarbon based resins, aromatic tackifying resins, and aromatically modified hydrocarbon based resins. Examples of such resins include Piccotac, Permalyn, Foralyn, and Tacolyn resins from Eastman Chemical Co.; and Norsolene and Wingtack® resins from Sartomer Co. Blends and mixtures of such resins may be used. The tackifying resin is generally present in an amount of from about 1 to about 20 wt % that of the (meth)acrylate adhesive polymer. Typically the tackifying resin is present in from about 1 to about 5 wt % that of the (meth)acrylate adhesive polymer

The adhesive formulation may be coated onto the flange of the cartridge tray by a variety of methods such as roll coating, reverse roll coating, knife coating, knife over roll coating, air knife coating, spray coating, drip coating, curtain coating, or screen coating. Spray coating using a plurality of fine nozzles is a convenient method. An optically opaque polymer can then be resealably mounted to the flange of the cartridge tray by the adhesive.

The following examples are provided to illustrate the practice of the present invention and the invention is not meant to be limited thereby.

### Materials and Methods for the Examples:

All materials used in the following examples are readily available from standard commercial sources, such as Aldrich Chemical Co. (Milwaukee, Wis.) unless otherwise specified. All percentages are by weight unless otherwise indicated. The following additional terms and materials were used.

Many of the chemical components used herein are provided as a solution. All amounts listed herein are the total amount of chemical component added unless otherwise specified.

FC-431 is an acrylate polymer having perfluorooctylsulfonyl groups. It was obtained from 3M Company, Maplewood, Minn. It is a solution of about 50% active ingredients.

FC-4432 is a nonionic surfactant and is believed to have the formula C₄F₉CH₂CH₂O(CH₂CH₂O)ₓH, where x is an integer denoting a polyethylene glycol. It was obtained from 3M Company, Maplewood, Minn.

Isopare® E is a mixture of predominantly C₈-C₉ isoparaffinic hydrocarbons. It is available from Exxon Mobil Chemicals, Houston, Tex.

Modiper F3035 is a polymeric fluorinated surfactant. It is believed to be a copolymer comprising 77 wt % of tridecyl methacrylate and 23 wt % of a fluorinated acrylate monomer having an ethylene bridge between the acrylate polymer backbone and a perfluorooctyl side-chain. It is also believed to have a molecular weight of about 27,600. It is available from Nippon Oils and Fats Corporation, Tokyo, Japan. It is a solution of about 30% active ingredients.

Morstik™ 607 is an acrylic, self cross-linking, pressure-sensitive polymeric adhesive (42±1.5% solids) in ethyl acetate and isopropyl alcohol. It is available from Rohm and Haas Company, Philadelphia, Pa. It is reported to contain approximately 85% 2-ethylhexylacrylate, 10% methylacrylate, 3% acrylic acid, and 2% vinyl acetate.

Norsolene® S-95 is a light colored low odor C₉ aromatic tackifying resin. It is available from Sartomer Company, Exton, Pa.

Permalyn™ 4100 resin is a hard pale synthetic thermoplastic pentaerythritol ester of rosin. It is a tackifying resin and is available from Eastman Chemical Company, Kingsport, Tenn.

Permalyn™ 5110-C synthetic resin is the pentaerythritol ester of gum rosin. It is a tackifying resin and is available from Eastman Chemical Company, Kingsport, Tenn.

Piccotac™ 7590-C hydrocarbon resin is an aromatic-modified, aliphatic (hydrocarbon) tackifier resin. It is a tackifying resin and is available from Eastman Chemical Company, Kingsport, Tenn.

Unidyne™ NS-1602 and NS-1603 are polymers of perfluoroalkyl (meth)acrylates, alkyl (meth)acrylates, vinyl chloride, and crosslinking monomers. They are available from Daikin America, Orangeberg, N.Y.

Wingtack® resins are synthetic resins obtained by cationic polymerisation of (C₅) aliphatic monomers. They are used in pressure sensitive adhesives (PSA) as tackifying resins and in hot melt adhesives (HMA) to increase adhesion strength. They are available from Sartomer Company, Exton, Pa. Wingtac® 86 is an aromatically modified C₅ hydrocarbon resin.

Zonyl® FSG is a nonionic fluorinated methacrylate polymer fluorosurfactant that is available from DuPont (Wilmington, Del.).

Zonyl® FSH, FSN-100, and FSO-100, are nonionic surfactants having the general formulae R_{f}CH₂CH₂O(CH₂CH₂O)_{w}H where R_{f} is CF₃CF₂(CF₂CF₂)ₙ, and n and w are integers indicating the number of ethylene glycol units. Zonyl® surfactants are available from DuPont (Wilmington, Del.).

### Determination of Peel Strength:

One method of determining if the adhesive forms a strong enough bond to be useful is to measure the peel strength of the cover material to the flange of the cartridge tray material. As noted above, the adhesive must be capable of providing a light-tight, resealable seal between the cover and flange of the film cartridge tray. In addition, to prevent the cover from sticking to itself as the cover is rolled back and forth during multiple opening and closing cycles, the adhesive must adhere more aggressively to the flange of the cartridge tray and not transfer to the cover sheet upon opening and closing.

The peel strength of the adhesive bond between the flange of the cartridge tray and the cover was tested using a custom-built peel force tester. The values obtained for the peel strength measured in pounds are believed to be comparable to those obtainable using commercially available peel strength testing equipment.

A resealable film cartridge substantially as described in U.S. Pat. No. 5,473,400 (noted above) was used for testing the peel strength. This patent is incorporated herein by reference and numbered features used in that patent are described herein. A sealed cartridge was placed on the test bed of the apparatus. The peel strength tester arm was attached to a bar containing teeth that fit into the apertures (46) of the cartridge. The cartridge was adhered to the test bed by vacuum. The cartridge was moved horizontally on the test bed at the same rate the head was moved vertically and the force required to peel back the cover at an angle of 90° was measured using a load cell. The signal was fed to a control box that gathered and transferred the data (force/time) to a computer through a serial interface. The peel strength (lb) was digitally displayed and stored for downloading into a spreadsheet.

### Evaluation of Samples:

Each coated and dried formulation was evaluated for visual appearance, peel strength, and adhesion using the criteria shown below.
1. Visual appearance: The physical appearance of the dried adhesive was evaluated to determine if the adhesive surface was smooth and without coating defects (such as orange peel or fish eyes).
2. Peel Strength Force: The peel strength was determined as described above. A peel strength between 0.8 and 1.8 lb is considered acceptable.
3. 180 Degree Manual Peel: The adhesion of the adhesive to the flange of the cartridge tray was evaluated by peeling the cover back at an angle of 180 degrees. Adhesive transfer to the cover is considered bad. Adhesive remaining attached to the flange of the cartridge tray is considered good.
4. Adhesion to the Flange of the Cartridge Tray: The adhesion of the adhesive to the flange of the cartridge tray was evaluated by manually rubbing dried adhesive surface with thumb.

### EXAMPLES

### Comparative Example 1

### Prior Art Adhesive Formulation

A comparative adhesive formulation was used as a benchmark. It contained the materials shown in TABLE I.

TABLE I
Formulation

| Ingredient | Sample | |
|---|---|---|
| Solution A: | C-1 | |
| Heptane | 20-34 | parts |
| Toluene | 28-32 | parts |
| Methylhexanes | 8-18 | parts |
| Dimethylpentanes | 1-7 | parts |
| Methylcyclohexane | 3-8 | parts |
| Iso-propyl Alcohol | 6-10 | parts |
| Acrylate Copolymer Adhesive | 9-10 | parts |
| Surfactant (3M FC-431) | 0.085 | parts |

The adhesive formulation was spray coated using compressed air through a set of narrow orifice tubes onto the flange of a cartridge tray. The adhesive was allowed to cure by heating for 14 minutes at 40° C. in a forced air convection oven. An optically opaque polymer cover comprising a laminate of aluminum, nylon, and polyethylene was then mounted to the flange of the cartridge tray by the adhesive. The polyethylene face was in contact with the flange.

The sealed cartridge was stored at room temperature for approximately 72 hours before peel strength was measured. Each coated and dried sample was then evaluated for visual appearance, peel strength, and adhesion using the criteria described above. Results are shown in TABLE II.

TABLE II
Evaluation of Sample

| | Sample |
|---|---|
| Criterion | C-1 |
| Visual Appearance | Benchmark |
| Average Peel Strength (lb) | 1.3 ± 0.5 lb |
| 180 Degree Manual Peel | Benchmark |
| Adhesion to Flange | Benchmark |

### Inventive Example 1

### Adhesive Formulation

Solution A: Solutions were prepared containing paraffinic hydrocarbon solvent, ester, alcohol, and acrylic adhesive. The amounts of these materials are shown in TABLE III. Stirring was maintained to ensure dissolution of the materials.

Solution B: A second solution was prepared containing a surfactant. The amounts of these materials are also shown in TABLE III. Stirring was maintained to ensure dissolution of the materials.

Solution B was added to Solution A.

Each adhesive formulation was spray coated using compressed air through a set of narrow orifice tubes onto the flange of a cartridge tray. The adhesive was allowed to cure by heating for 14 minutes at 40° C. in a forced air convection oven. An optically opaque polymer cover was then mounted to the flange of the cartridge tray by the adhesive.

The sealed cartridge was stored at room temperature for approximately 72 hours before peel strength was measured. Each coated and dried sample was then evaluated for visual appearance, peel strength, and adhesion using the criteria described above.

The results, shown below in TABLE IV, demonstrate the following:

Sample 1-1 demonstrates that an isoparaffinic hydrocarbon solvent having a too low a boiling point (hexane) results in a poor visual appearance of the coated adhesive.

Sample 1-2 demonstrates that an isoparaffinic hydrocarbon solvent having too high a boiling point (Isopar G) adversely affects peel strength.

Sample 1-3 demonstrates that a paraffinic hydrocarbon solvent (heptane) having a boiling point between about 94 and 140° C. provides an adhesive similar to that of the benchmark.

Sample 1-4 demonstrates that an isoparrafinic hydrocarbon solvent (Isopar E) provides an adhesive with improved visual appearance and peel strength to that of the benchmark. Additionally Sample 1-4 demonstrates that a fluorochemical surfactant present at 0.08 parts works well.

Sample 1-5 demonstrates the need for a paraffinic hydrocarbon solvent in the adhesive formulation in order to provide adequate peel strength and adhesion of the cover to the flange.

Sample 1-6 demonstrates the utility of a particular ester (n-butyl acetate).

Samples 1-7, 1-8, 1-10, and 1-11 demonstrate that a surfactant containing a perfluoroalkyl groups attached to an ethylene group that is attached to an ethylene glycol group or a polyethylene glycol group provides an adhesive with a poor visual appearance.

Sample 1-9 demonstrates than a surfactant containing a nonionic fluorinated methacrylate polymer provides an adhesive with visual appearance better than that of the benchmark adhesive.

Sample 1-12 demonstrates that having a surfactant below 0.05 parts provides an adhesive with poor visual appearance.

Sample 1-13 demonstrates that incorporating a between 0.05 and 0.5 parts of a surfactant provides an adhesive with improved visual properties and adhesion of the cover to the flange without loss of other desired properties.

Sample 1-14 demonstrates that incorporating greater than 0.5 parts of surfactant provides no additional benefit.

TABLE III
Formulations

| | Sample | | | | |
|---|---|---|---|---|---|
| Ingredient | 1-1 | 1-2 | 1-3 | 1-4 | 1-5 |
| Solution A: | | | | | |
| Paraffinic Hydrocarbon | n-heptane | Isopar E | n-heptane | Isopar E | None |
| | 38.4 parts | 15.4 | 53.3 parts | 61.7 | |
| | n-hexane | Isopar G | | | |
| | 22.6 parts | 46.3 | | | |
| Ester | n-propyl acetate | n-propyl acetate | n-propyl acetate | n-propyl acetate | n-propyl acetate |
| | 20.6 parts | 18.1 parts | 28.1 parts | 18.1 parts | 44.8 parts |
| | | | | | ethyl acetate |
| | | | | | 44.8 parts |
| Alcohol | iso-propanol | iso-propanol | iso-propanol | iso-propanol | None |
| | 8.14 parts | 9.95 parts | 8.15 parts | 9.95 parts | |
| Acrylate Adhesive | 3M V-19800 | 3M V-19800 | 3M V-19800 | 3M V-19800 | 3M V-19800 |
| | 9.49 parts | 9.49 parts | 9.49 parts | 9.49 parts | 9.4 parts |
| Solution B | | | | | |
| Solvent | n-heptane | n-heptane | n-heptane | Isopar E | n-propyl acetate |
| | 0.72 parts | 0.72 parts | 0.90 parts | 0.72 parts | 0.45 parts |
| | | | | | ethyl acetate |
| | | | | | 0.45 parts |
| Surfactant | Modiper F3035 | Modiper F3035 | Modiper F3035 | Modiper F3035 | FC-431 |
| | 0.08 parts | 0.08 parts | 0.10 parts | 0.08 parts | 0.10 parts |
| | Sample | | | | |
| Ingredient | 1-6 | 1-7 | 1-8 | 1-9 | 1-10 |
| Solution A: | | | | | |
| Paraffinic Hydrocarbon | Isopar E | Isopar E | Isopar E | Isopar E | Isopar E |
| | 67.0 parts | 60 parts | 60 parts | 60 parts | 60 parts |
| Ester | n-butyl acetate | n-propyl acetate | n-propyl acetate | n-propyl acetate | n-propyl acetate |
| | 17.2 parts | 18 parts | 18 parts | 18 parts | 18 parts |
| Alcohol | iso-propanol | iso-propanol | iso-propanol | iso-propanol | iso-propanol |
| | 3.8 parts | 10 parts | 10 parts | 10 parts | 10 parts |
| Acrylate Adhesive | 3M V-19800 | 3M V-19800 | 3M V-19800 | 3M V-19800 | 3M V-19800 |
| | 9.49 parts | 9.5 parts | 9.5 parts | 9.5 parts | 9.5 parts |
| Solution B | | | | | |
| Solvent | Isopar E | n-propyl acetate | n-propyl acetate | n-propyl acetate | n-propyl acetate |
| | 2.15 parts | 7.2 parts | 7.2 parts | 14.4 parts | 2.9 parts |
| Surfactant | Modiper F3035 | Zonyl FSO-100 | Zonyl FSN-100 | Zonyl FSG | Zonyl FSH |
| | 0.32 parts | 0.3 | 0.3 | 0.6 | 0.1 |

Sample

| Ingredient | 1-11 | 1-12 | 1-13 | 1-14 |
|---|---|---|---|---|
| Solution A: | | | | |
| Paraffinic Hydrocarbon | Isopar E | Isopar E | Isopar E | Isopar E |
| | 61 parts | 60 parts | 60 parts | 60 parts |
| Ester | n-propyl acetate | n-propyl acetate | n-propyl acetate | n-propyl acetate |
| | 18.1 parts | 18.1 parts | 18.1 parts | 18.1 parts |
| Alcohol | iso-propanol | iso-propanol | iso-propanol | iso-propanol |
| | 9.95 parts | 9.95 parts | 9.95 parts | 9.95 parts |
| Acrylate Adhesive | 3M V-19800 | 3M V-19800 | 3M V-19800 | 3M V-19800 |
| | 9.49 parts | 9.49 parts | 9.49 parts | 9.49 parts |
| Solution B | | | | |
| Solvent | iso-propanol | Isopar E | Isopar E | Isopar E |
| | 1.20 | 2.43 | 2.15 | 1.83 |
| Surfactant | FC-4432 | Modiper F3035 | Modiper F3035 | Modiper F3035 |
| | 0.32 | 0.04 parts | 0.32 parts | 0.64 parts |

TABLE IV
Evaluation of Samples

| | Sample | | | | |
|---|---|---|---|---|---|
| Criterion | 1-1 | 1-2 | 1-3 | 1-4 | 1-5 |
| Visual Appearance | Worse than | Same as | Same as | Better than | Same as |
| | Benchmark | Benchmark | Benchmark | Benchmark | Benchmark |
| Peel Strength (lb) | 1.16 | 0.24 | 0.98 | 1.32 | 1.06 |
| 180 Deg Manual Peel | Same as | Same as | Same as | Same as | Much Worse than |
| | Benchmark | Benchmark | Benchmark | Benchmark | Benchmark |
| Adhesion to Flange | Same as | Same as | Same as | Better than | Much Worse than |
| | Benchmark | Benchmark | Benchmark | Benchmark | Benchmark |

| | Sample | | | | |
|---|---|---|---|---|---|
| Criterion | 1-6 | 1-7 | 1-8 | 1-9 | 1-10 |
| Visual Appearance | Better than | Much worse than | Much worse than | Better than | Much worse than |
| | Benchmark | Benchmark | Benchmark | Benchmark | Benchmark |
| Peel Strength (lb) | 1.0 | Not Run | Not Run | Not Run | Not Run |
| 180 Deg Manual Peel | Better than | Not Run | Not Run | Not Run | Not Run |
| | Benchmark | | | | |
| Adhesion to Flange | Better than | Not Run | Not Run | Not Run | Not Run |
| | Benchmark | | | | |

Sample

| Criterion | 1-11 | 1-12 | 1-13 | 1-14 |
|---|---|---|---|---|
| Visual Appearance | Much Worse than | Much Worse than | Better than | Better than |
| | Benchmark | Benchmark | Benchmark | Benchmark |
| Peel Strength (lb) | 0.8 | 0.8 | 1.1 | 0.9 |
| 180 Deg Manual Peel | Much worse than | Same as | Same as | Same as |
| | Benchmark | Benchmark | Benchmark | Benchmark |
| Adhesion to Flange | Worse than | Same as | Better than | Better than |
| | Benchmark | Benchmark | Benchmark | Benchmark |

### Inventive Example 2

### Adhesive Formulations Containing Tackifying Resins

Solution A: Solutions were prepared containing paraffinic hydrocarbon solvent, ester, alcohol, acrylic adhesive, and tackifying resin. The amounts of these materials are shown in Table V. Stirring was maintained to ensure dissolution of the materials.

Solution B: A second solution was prepared containing a surfactant. The amounts of these materials are also shown in Table I. Stirring was maintained to ensure dissolution of the materials.

Solution B was added to Solution A.

Each adhesive formulation was spray coated using compressed air through a set of narrow orifice tubes onto the flange of a cartridge tray. The adhesive was allowed to cure by heating for 14 minutes at 40° C. in a forced air convection oven. An optically opaque polymer cover was then mounted to the flange of the cartridge tray by the adhesive. The sealed cartridge was stored at room temperature for approximately 72 hours before peel strength was measured. Each coated and dried sample was then evaluated for visual appearance, peel strength, and adhesion using the criteria described above.

The results, shown below, in Table VI demonstrate the following:

Sample 2-1 demonstrates the utility of Morstik-607 acrylate adhesive in the adhesive formulation. It showed improved properties compared to those of the benchmark adhesive except for visual appearance.

Sample 2-2 demonstrates the utility of Wingtack-86 as a tackifying resin in the adhesive formulation. It showed improved properties compared to those of the benchmark adhesive.

Sample 2-3 demonstrates the utility of Norsolene S-95 as a tackifying resin in the adhesive formulation. It showed improved properties compared to those of the benchmark adhesive.

Sample 2-4 demonstrates the utility of Permalyn 4100 as a tackifying resin in the adhesive formulation.

Sample 2-5 demonstrates the utility of Permalyn 5110-C as a tackifying resin in the adhesive formulation. It showed improved properties compared to those of the benchmark adhesive.

Sample 2-6 demonstrates the utility of Piccotac 7590C as a tackifying resin in the adhesive formulation. It showed improved properties compared to those of the benchmark adhesive. Its peel strength was somewhat high.

TABLE V
Formulations Containing Tackifying Resins

| | Sample | | | | | |
|---|---|---|---|---|---|---|
| Ingredient | 2-1 | 2-2 | 2-3 | 2-4 | 2-5 | 2-6 |
| Solution A: | | | | | | |
| Paraffinic | Isopar E | Isopar E | Isopar E | Isopar E | Isopar E | Isopar E |
| Hydrocarbon | 59.6 parts | 59.6 parts | 59.6 parts | 59.6 parts | 59.6 parts | 59.6 parts |
| Ester | n-propyl acetate | n-propyl acetate | n-propyl acetate | n-propyl acetate | n-propyl acetate | n-propyl acetate |
| | 9.2 parts | 18 parts | 18 parts | 18 parts | 18 parts | 18 parts |
| Alcohol | iso-propanol | iso-propanol | iso-propanol | iso-propanol | iso-propanol | iso-propanol |
| | 6.1 parts | 9.9 parts | 9.9 parts | 9.9 parts | 9.9 parts | 9.9 parts |
| Acrylate Adhesive | Morstik-607 | 3M V-19800 | 3M V-19800 | 3M V-19800 | 3M V-19800 | 3M V-19800 |
| | 22.3 parts (42%) | 9.7 | 9.7 | 9.7 | 9.7 | 9.7 |
| | 9.4 parts (net) | | | | | |
| Tackifying Resin | Wingtack-86 | Wingtack-86 | Norsolene S-95 | Permalyn 4100 | Permalyn 5110C | Piccotac 7590C |
| | 0.2 parts | 0.3 parts | 0.3 parts | 0.3 parts | 0.3 parts | 0.3 parts |
| Solution B | | | | | | |
| Solvent | Isopar E | Isopar E | Isopar E | Isopar E | Isopar E | Isopar E |
| | 2.3 parts | 2.3 parts | 2.3 parts | 2.3 parts | 2.3 parts | 2.3 parts |
| Surfactant | Modiper F3035 | Modiper F3035 | Modiper F3035 | Modiper F3035 | Modiper F3035 | Modiper F3035 |
| | 0.34 parts | 0.34 parts | 0.34 parts | 0.34 parts | 0.34 parts | 0.34 parts |

TABLE VI
Evaluation of Samples Containing Tackifying Resins

| | Sample | | | | | |
|---|---|---|---|---|---|---|
| Criterion | 2-1 | 2-2 | 2-3 | 2-4 | 2-5 | 2-6 |
| Visual Appearance | Worse than | Better than | Better than | Better than | Better than | Better than |
| | Benchmark | Benchmark | Benchmark | Benchmark | Benchmark | Benchmark |
| Peel Strength (lb) | 1.5 | 1.7 | 1.2 | 1.4 | 1.4 | 1.9 |
| 180 Deg Manual Peel | Better than | Better than | Better than | Same as | Better than | Better than |
| | Benchmark | Benchmark | Benchmark | Benchmark | Benchmark | Benchmark |
| Adhesion to Flange | Better than | Better than | Better than | Better than | Better than | Better than |
| | Benchmark | Benchmark | Benchmark | Benchmark | Benchmark | Benchmark |

The invention has been described in detail with particular reference to certain preferred embodiments thereof, but it will be understood that variations and modifications can be effected within the spirit and scope of the invention.

1. A resealable adhesive formulation comprising:
(a) from about 50 to about 75 wt % of a paraffinic hydrocarbon having a boiling point of between about 94 and about 140° C.;
(b) from about 10 to about 25 wt % of an aliphatic ester having 10 or fewer carbon atoms;
(c) from about 5 to about 15 wt % of an aliphatic alcohol having 5 or fewer carbon atoms;
(d) from about 5 to about 15 wt % of a (meth)acrylate adhesive; and
(e) from about 0.05 to about 0.7 wt % of a surfactant free of perfluoro-alkylsulfonyl groups and containing perfluoroalkyl groups or perfluoroalkyl groups attached to an ethylene group pendant from a polymer chain.

2. The resealable adhesive formulation of claim 1 wherein the paraffinic hydrocarbon is an isoparaffinic hydrocarbon.

3. The resealable adhesive formulation of claim 1 wherein the paraffinic hydrocarbon is present in an amount of from about 55 to about 65 wt % of the adhesive formulation.

4. The resealable adhesive formulation of claim 1 wherein the aliphatic ester is present in an amount of from about 15 to about 20 wt % of the adhesive formulation.

5. The resealable adhesive formulation of claim 1 wherein the aliphatic alcohol is present in an amount of from about 8 to about 12 wt % of the adhesive formulation.

6. The resealable adhesive formulation of claim 1 wherein the (meth)acrylate adhesive comprises from 100 to about 80 wt % of a C₃ to C₁₂ alkyl ester (meth)acrylate.

7. The resealable adhesive formulation of claim 1 wherein the acrylate adhesive is present in an amount of from about 7 to about 12 wt % of the adhesive formulation.

8. The resealable adhesive formulation of claim 1 wherein the surfactant free of perfluoroaklylsulfonyl groups contains one or more perfluoroalkyl or perfluoroalkylethylene groups

9. The resealable adhesive formulation of claim 8 wherein the surfactant free of perfluoroaklylsulfonyl groups also contains one or more ethylene glycol groups attached to the perfluoroalkyl or perfluotoalkylethylene groups.

10. The resealable adhesive formulation of claim 1, further comprising a tackifying resin in an amount of from about 1 to about 20 wt % of the acrylic polymer.

11. The resealable adhesive formulation of claim 10, wherein the tackifying resin is present in an amount of from about 1 to about 5 wt % of the acrylic polymer.

12. The resealable adhesive formulation of claim 10, wherein the tackifying resin is a terpene-based resin, rosin-based resin, aliphatic hydrocarbon based resin, aromatic hydrocarbon based resin, or blends or mixtures thereof.

13. The resealable adhesive formulation of claim 12, wherein the tackifying resin is a terpene-based resin, rosin-based resin, aliphatic hydrocarbon based resin, aromatic hydrocarbon based resin, or blends or mixtures thereof.

14. The resealable adhesive formulation of claim 12, wherein the tackifying resin is an aromatic tackifying resin, an aromatically modified hydrocarbon resin, or an ester of gum rosin or mixtures thereof.

15. A resealable adhesive formulation comprising:
(a) from about 55 to about 65 wt % of an isoparaffinic hydrocarbon having a boiling point of between about 94 and about 140° C.;
(b) from about 15 to about 20 wt % of an aliphatic ester having 10 or fewer carbon atoms;
(c) from about 8 to about 12 wt % of an aliphatic alcohol having 5 or fewer carbon atoms;
(d) from about 7 to about 12 wt % a (meth)acrylate adhesive comprising from 100 to about 80 wt % of a C₃ to C₁₂ alkyl ester (meth)acrylate;
(e) a tackifying resin in an amount of from about 1 to about 5 wt % that of the acrylate adhesive polymer; and
(f) from about 0.05 to about 0.7 wt % of a surfactant free of perfluoro-alkylsulfonyl groups that is a poly(meth)acrylate copolymer containing one or more perfluoroalkyl groups or perfluoroalkyl groups attached to an ethylene group and also containing one or more alkyl groups pendant from a polyacrylate or polymethacrylate chain.

16. The resealable adhesive formulation of claim 15 wherein the aliphatic ester is n-propyl acetate, the aliphatic alcohol is iso-propyl alcohol, and the tackifying resin is an aliphatic hydrocarbon based resin or an aromatic hydrocarbon based resin.

17. A cassette or cartridge comprising a cartridge tray having a flange with the adhesive of claim 15 disposed thereon.

18. A method of sealing a cassette or cartridge comprising:
(a) applying the adhesive of claim 15 to the flange of the cassette or cartridge tray;
(b) drying the adhesive; and
(c) applying a flexible cover to the adhesively coated flange of the cassette or cartridge tray.

19. The cassette or cartridge prepared by the method of claim 18.

20. The cassette or cartridge prepared by the method of claim 20 wherein the peel strength between the cover and flange of the cassette is between 0.8 and 1.8 lb.
